(19) United States
(12) Patent Application Publication
(10) Pub. No.: US 2014/0369743 A1
(43) Pub. Date: Dec. 18, 2014

(54) ELASTIC RETAINING ASSEMBLY FOR MATABLE COMPONENTS AND METHOD OF ASSEMBLING

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(21) Appl. No.: 13/918,183

(22) Filed: Jun. 14, 2013

(51) Int. Cl. F16B 17/00

(52) U.S. Cl. CPC F16B 17/002
USPC 403/280; 29/450

(57) ABSTRACT

An elastic retaining assembly for matable components includes a first component having a first surface. Also included is a second component configured to be mated with the first component, the second component comprising a second surface. Further included is a receiving feature formed proximate an engagement side of the second component, the receiving feature having a first degree of curvature. Yet further included is an elastically deformable protrusion operatively coupled to, and extending away from, the first component, the elastically deformable protrusion having a second degree of curvature distinct from the first degree of curvature of the receiving feature, wherein the elastically deformable protrusion is formed of an elastically deformable material and configured to elastically deform upon engagement with the receiving feature.

### FIELD OF THE INVENTION

The invention relates to matable components and, more particularly, to an elastic retaining assembly for such matable components, as well as a method of assembling the matable components.

### BACKGROUND

Currently, components which are to be mated together in a manufacturing process are subject to positional variation based on the mating arrangements between the components. One common arrangement includes components mutually located with respect to each other by 2-way and/or 4-way male alignment features; typically undersized structures which are received into corresponding oversized female alignment features such as apertures in the form of openings and/or slots. Alternatively, double-sided tape, adhesives or welding processes may be employed to mate parts. Irrespective of the precise mating arrangement, there is a clearance between at least a portion of the alignment features which is predetermined to match anticipated size and positional variation tolerances of the mating features as a result of manufacturing (or fabrication) variances. As a result, occurrence of significant positional variation between the mated components is possible, which contributes to the presence of undesirably large and varying gaps and otherwise poor fit. The clearance between the aligning and attaching features may lead to relative motion between mated components, which contribute to poor perceived quality. Additional undesirable effects may include squeaking and rattling of the mated components, for example.

### SUMMARY OF THE INVENTION

In one exemplary embodiment, an elastic retaining assembly for matable components includes a first component comprising a first surface. Also included is a second component configured to be mated with the first component, the second component comprising a second surface. Further included is a receiving feature formed proximate an engagement side of the second component, the receiving feature having a first degree of curvature. Yet further included is an elastically deformable protrusion operatively coupled to, and extending away from, the first component, the elastically deformable protrusion having a second degree of curvature distinct from the first degree of curvature of the receiving feature, wherein the elastically deformable protrusion is formed of an elastically deformable material and configured to elastically deform upon engagement with the receiving feature.

In another exemplary embodiment, an elastic retaining assembly for matable components includes a first component. Also included is a second component configured to be mated with the first component. Further included is a receiving feature formed proximate an engagement side of the second component, the receiving feature comprising a main portion and a retention portion proximate an end of the receiving feature. Yet further included is an elastically deformable protrusion operatively coupled to, and extending away from, the first component, wherein the elastically deformable protrusion is formed of an elastically deformable material and is configured to elastically deform upon engagement with the receiving feature.

In yet another exemplary embodiment, a method of assembling matable components is provided. The method includes inserting an elastically deformable protrusion of a first component into a receiving feature of a second component. The method also includes contacting an outer surface of the elastically deformable protrusion with the receiving feature to impose a contact interference condition between the first component and the second component. The method further includes bending the elastically deformable protrusion away from a protrusion natural degree of curvature during insertion into the receiving feature. The method yet further includes elastically deforming the elastically deformable protrusion upon contacting the receiving feature. It also may include seating into an end notch that retains it.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a plan view of an elastic retaining assembly in a fully engaged position;

FIG. 2 is a plan view of a first component of the elastic retaining assembly;

FIG. 3 is a plan view of a second component of the elastic retaining assembly;

FIG. 4 is a plan view of the elastic retaining assembly in a partially engaged position;

FIG. 5 is a perspective view of the first component according to another aspect of the invention;

FIG. 6 is a plan view of the second component according to another aspect of the invention;

FIG. 7 is a perspective view of the first component according to another aspect of the invention;

FIG. 8 is a plan view of the second component according to another aspect of the invention; and

FIG. 9 is a flow diagram illustrating a method of assembling matable components.

### DESCRIPTION OF THE EMBODIMENTS

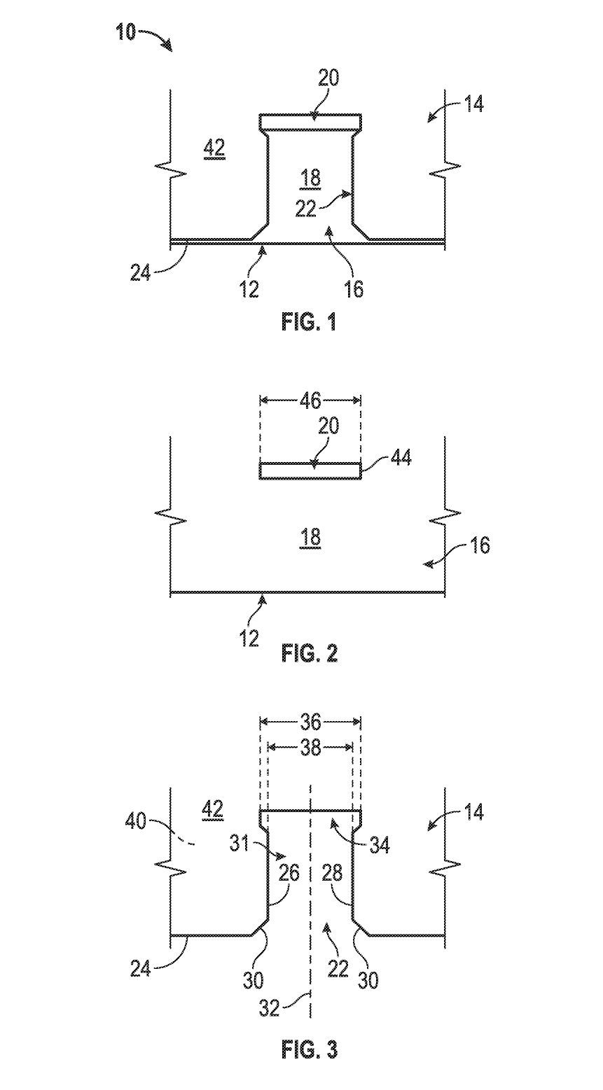

Referring to FIGS. 1-3, an elastic retaining assembly 10 is illustrated. The elastic retaining assembly 10 comprises matable components, such as a first component 12 and a second component 14 that are configured to be mated and aligned with respect to each other. In one embodiment, the elastic retaining assembly 10 is employed in a vehicle application. However, it is to be understood that the components may be associated with numerous other applications and industries, such as home appliance and aerospace applications, for example. In an exemplary embodiment such as the aforementioned vehicle application, the first component 12 comprises an automotive air deflector and the second component 14 comprises an automotive fascia.

Although illustrated in a specific geometry, the first component 12 and the second component 14 may be configured in countless geometries. Regardless of the precise geometry of the first component 12 and the second component 14, the first component 12 is configured to align and fittingly mate with the second component 14, which will be described in detail below. In another embodiment, rather than two components comprising the elastic retaining assembly 10, additional or intermediate layers or components may be included. It is to be appreciated that the elastic retaining assembly 10 is to be employed for providing a self-aligning relationship between components, such as the first component 12 and the second component 14, to each other, while also assisting in securely mating the components to each other in a tight, fitted manner that reduces vibration and/or relative motion between the components.

The first component 12 includes a base portion 16 having a first surface 18 that is typically a substantially planar surface. The first component 12 also includes an elastically deformable protrusion 20 (illustrated in detail in FIG. 5) extending from the base portion 16 in a direction relatively orthogonal from a plane that the first surface 18 is disposed in. The elastically deformable protrusion 20 is operatively coupled to the base portion 16 and may be integrally formed with the base portion 16. The second component 14 includes a receiving feature 22 formed proximate to, and extending inwardly from, an engagement side 24 as a cutout portion, or notch, that is configured to engage and receive the elastically deformable protrusion 20 upon mating of the first component 12 and the second component 14. Although a single elastically deformable protrusion and a single receiving feature are referenced, embodiments of the elastic retaining assembly 10 may include a plurality of elastically deformable protrusions and a plurality of receiving features, as will be described in detail below.

The elastically deformable protrusion 20 and the receiving feature 22 may be formed as numerous contemplated embodiments. In the exemplary embodiment, the elastically deformable protrusion 20 comprises an upstanding wall that is substantially planar, but a slight degree of curvature is contemplated. Alternatively, the elastically deformable protrusion 20 is formed as a relatively cylindrical or tubular member that may be a solid tubular member or a tubular member having a hollow portion. In yet another embodiment, the elastically deformable protrusion 20 is completely or partially spherical. In one embodiment, a pin portion and a head portion is included, wherein the head portion is formed of a bulbous structure that smoothly blends with the pin portion. The preceding embodiment descriptions are merely illustrative and are not intended to be limiting of the numerous shapes that the elastically deformable protrusion 20 may be comprised of

The receiving feature 22 comprises a notched cutout that extends inwardly from the engagement side 24 and is defined by a first edge 26 and a second edge 28 (FIG. 3). The first edge 26 and the second edge 28 each extend from the engagement side 24 and may include an insert guide portion 30 that operates as a “lead-in” for a smooth insertion of the elastically deformable protrusion 20 as it is translated into a main portion 31 of the receiving feature 22. Although not illustrated, as the first edge 26 and the second edge 28 extend inwardly from the engagement side 24, it is contemplated that one or both of the first edge 26 and the second edge 28 angles inwardly toward each other, as well as toward axis 32 that is substantially co-axial with the substantially straight elastically deformable protrusion 20. In the illustrated embodiment, the receiving feature 22 also includes a retention portion 34. The retention portion 34 is defined by a retention portion surface that geometrically corresponds substantially to the elastically deformable protrusion 20. The retention portion 34 is larger than the main portion 31. More specifically, the retention portion 34 comprises a retention portion width 36 and the main portion 31 comprises a main portion width 38, wherein the retention portion width 36 is greater than the main portion width 38. The receiving feature 22 effectively forms an opening extending through the second component 14 from a second surface 40 to a third surface 42.

As will be apparent from the description herein, the elastically deformable nature of the protrusions, in combination with the particular orientations described above, facilitates precise alignment of the first component 12 relative to the second component 14 by accounting for positional variation of the retaining and/or locating features of the first component 12 and the second component 14 inherently present due to manufacturing processes. The self-aligning benefits associated with the elastic retaining assembly 10 will be described in detail below.

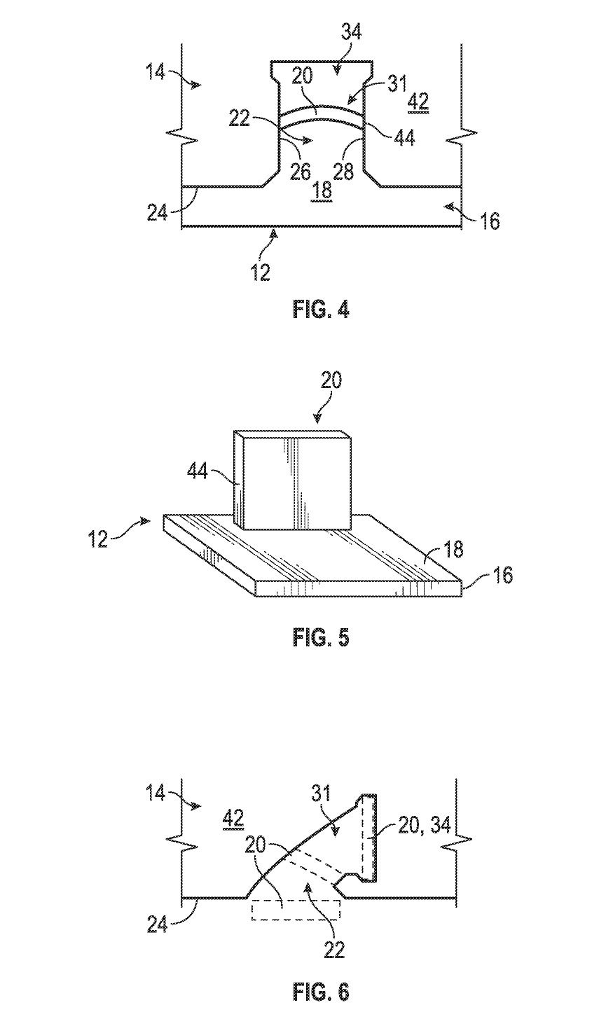

The elastically deformable protrusion 20 of the first component 12 is positioned and engaged with the receiving feature 22 of the second component 14 upon translation of the first component 12 toward the second component 14 (FIG. 4). In this way, the first component 12 is press fit into the second component 14 upon engagement of the elastically deformable protrusion 20 with the main portion 31 of the receiving feature 22. More particularly, an outer surface 44 of the elastically deformable protrusion 20 engages the first edge 26 and the second edge 28. The outer surface 44 comprises an outer surface width 46 that is greater than the main portion width 38, thereby ensuring contact and deformation of the elastically deformable protrusion 20 upon further insertion into the main portion 31 of the receiving feature 22. The elastically deformable protrusion 20 is illustrated in FIG. 4 in a deformed condition in a partially inserted position of the first component 12. Elastic deformation of the elastically deformable protrusion 20 may be further facilitated by embodiments comprising a hollow portion. The void of material proximate the hollow portion enhances the flexibility of the elastically deformable protrusion 20. Regardless of whether the elastically deformable protrusion 20 is solid or hollow, the elastically deformable protrusion 20 is further translated through the main portion 31 and into the retention portion 34. Upon reaching the retention portion 34, a portion of the elastically deformable protrusion 20 expands slightly to conform to the shape of the retention portion 34. The expansion of the elastically deformable protrusion 20 may be partial to a still-deformed condition or substantially back to an original position. Irrespective of the degree of expansion, the retention portion 34 provides an additional retention force on the elastically deformable protrusion 20, thereby increasing stability of the first component 12 relative to the second component 14.

Referring now to FIG. 6, the second component 14 is illustrated according to an alternate embodiment. Specifically, the receiving feature 22 of the second component 14 comprises an angled or curved shape having a first degree of curvature. In the illustrated embodiment, the elastically deformable protrusion 20 includes a second degree of curvature that is distinct from the first degree of curvature of the receiving feature 22. In operation, upon insertion of the elastically deformable protrusion 20 into the receiving feature 22, the elastically deformable protrusion 20 is forced to elastically deform upon engagement with the receiving feature 22. In this embodiment, the deformation results from two primary factors. First, as is the case with the embodiments described above, the outer surface width 46 is greater than the main portion width 38. Second, the distinct degrees of curvature impose bending of the elastically deformable protrusion 20 upon engagement with the receiving feature 22. The additional contact interference enhances the retention properties of the assembly. Upon reaching the fully engaged position, the elastically deformable protrusion 20 is bent to a point that the first degree of curvature of the receiving feature 22 and the second degree of curvature of the elastically deformable protrusion 20 are substantially equal. For illustration purposes, the elastically deformable protrusion 20 is shown in the three above-described conditions. Specifically, a pre-insertion condition, a partially inserted condition and a fully inserted condition is illustrated in phantom.

In yet another embodiment, it is contemplated that the receiving feature 22 lacks the retention feature 34 (FIG. 8) described in detail above in relation to other embodiments. In such an embodiment, a contact interference condition established between portions of the outer surface 44 of the elastically deformable protrusion 20 and the receiving feature 22 sufficiently retains the elastically deformable protrusion 20, and therefore the first component 12. To reiterate, this is facilitated by the larger width of the elastically deformable protrusion 20, relative to the receiving feature 22, as well as bending of the elastically deformable protrusion 20 in embodiments comprising distinct degrees of curvature, with respect to the elastically deformable protrusion 20 and the receiving feature 22. In another embodiment, the elastically deformable protrusion 20 is not wider than the receiving feature 22 if a less compliant material is employed. Distinct curvatures between the elastically deformable protrusion 20 and the receiving feature 22 cause an interference that results in the two elastically deformable protrusions 20 bending and working to have a centering effect or to push to one side of the other to have a directional effect.

Any suitable elastically deformable material may be used for the elastically deformable protrusion 20. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the elastically deformable protrusion 20. The predetermined elastic response characteristic may include, for example, a predetermined elastic modulus.

The precise position where engagement between the outer surface 44 and the receiving feature 22 occurs will vary depending on positional variance imposed by manufacturing factors. Due to the elastically deformable properties of the elastic material comprising the elastically deformable protrusion 20, the criticality of the initial location of engagement is reduced. Further insertion of the elastically deformable protrusion 20 into the receiving feature 22 ultimately leads to a fully engaged position of the elastically deformable protrusion 20. In the fully engaged position, a tight, fitted engagement between the elastically deformable protrusion 20 and the receiving feature 22 is achieved by contact interface between the outer surface 44 and the receiving feature 22. Such a condition is ensured by sizing the protrusion to have a larger width than the receiving feature. The interference between the outer surface 44 and the first edge 26 and the second edge 28 of the receiving feature 22 causes elastic deformation proximate the outer surface 44. The malleability of the materials reduces issues associated with positional variance. More particularly, in contrast to a rigid insert that typically results in gaps between the insert and receiving structure at portions around the perimeter or outer surface of the insert, the elastically deformable protrusion 20 advantageously deforms to maintain alignment of the first component 12 and the second component 14, while also reducing or eliminating gaps associated with manufacturing challenges.

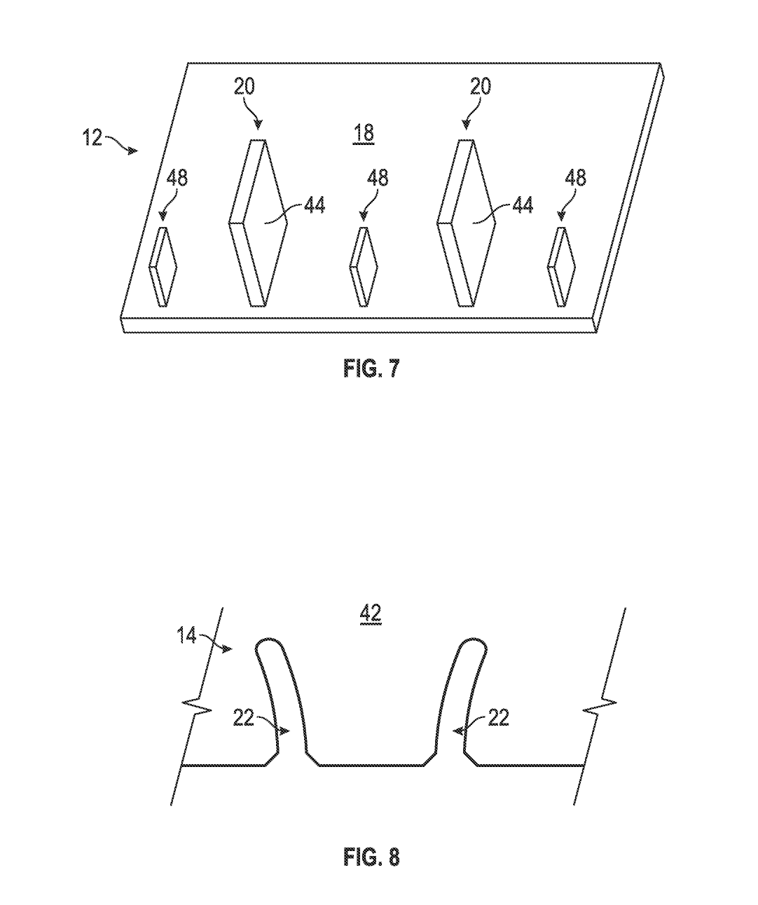

Any embodiments described herein may include at least one (but often a plurality of) intermediate structural member, referred to as a standoff 48 (FIG. 7), operatively coupled to the first surface 18 and/or the second surface 40 (FIG. 3). Translation of the first component 12 toward and into the second component 14 results in contact with each other proximate the standoff 48. Such engagement assists an installation operator to ensure proper positioning of the first component 12 relative to the second component 14 upon translation of the elastically deformable protrusion 20 into the receiving feature 22, thereby leading to a more robust assembly condition. The standoff(s) 48 move the contact points up the beams to allow them to flex and the height of the standoff(s) 48 is based on material properties of arrangement components, thereby avoiding contact too close to the first surface 18. Contact at regions too close to the first surface 18 result in overly rigid portions of the elastically deformable protrusion 20.

Referring to FIGS. 7 and 8, the first component 12 may include a plurality of elastically deformable protrusions, while the second component 14 may include a plurality of receiving features. The plurality of receiving features is positioned to correspondingly receive respective protrusions in a manner described in detail above. In particular, the elastically deformable protrusion(s) 20 bend inwardly or outwardly in response to interaction with the edge of the receiving feature(s) 22. The elastic deformation of the plurality of elastically deformable protrusions elastically averages any positional errors of the first component 12 and the second component 14. In other words, gaps that would otherwise be present due to positional errors associated with portions or segments of the first component 12 and the second component 14, particularly locating and retaining features, are eliminated by offsetting the gaps with an over-constrained condition of other elastically deformable protrusions. Specifically, the positional variance of each protrusion and/or receiving feature is offset by the remaining protrusions to average, in aggregate, the positional variance of each protrusion.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles to an assembly that does facilitate elastic averaging and the benefits associated therewith.

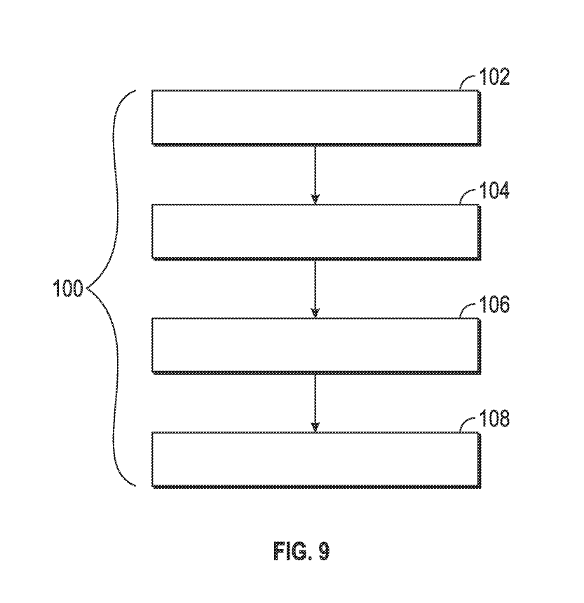

A method of elastically assembling matable components 100 is also provided, as illustrated in FIG. 9, and with reference to FIGS. 1-8. The elastic retaining assembly 10, as well as the elastically deformable nature of the elastically deformable protrusion 20, has been previously described and specific structural components need not be described in further detail. The method 100 includes inserting 102 the elastically deformable protrusion 20 of the first component 12 into a receiving feature 22 of the second component 14. The method 100 also includes contacting 104 the outer surface 44 of the elastically deformable protrusion 20 with the receiving feature 22 to impose a contact interference condition between the first component 12 and the second component 14. The method 100 further includes bending 106 the elastically deformable protrusion 20 away from a protrusion 20 away from the protrusion natural degree of curvature during insertion into the receiving feature 22. The method 100 yet further includes elastically deforming 108 the elastically deformable protrusion 20 upon contacting 104 the receiving feature 22.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic retaining assembly for matable components comprising:
a first component having a first surface;
a second component configured to be mated with the first component, the second component comprising a second surface;
a receiving feature formed proximate an engagement side of the second component, the receiving feature having a first degree of curvature; and
an elastically deformable protrusion operatively coupled to, and extending away from, the first component, the elastically deformable protrusion having a second degree of curvature distinct from the first degree of curvature of the receiving feature in an unmated condition, wherein the elastically deformable protrusion is formed of an elastically deformable material and configured to elastically deform upon engagement with the receiving feature.

2. The elastic retaining assembly of claim 1, further comprising a fully engaged position of the first component, wherein the fully engaged position comprises contact interference between an outer surface of the elastically deformable protrusion with the receiving feature, wherein an amount of deformation along the outer surface is averaged in aggregate.

3. The elastic retaining assembly of claim 2, wherein the first degree of curvature and the second degree of curvature are substantially equal in the fully engaged position.

4. The elastic retaining assembly of claim 1, further comprising at least one standoff operatively coupled to, and extending away from, the first component and configured to engage the second surface of the second component.

5. The elastic retaining assembly of claim 1, wherein the receiving feature further comprises a main portion and a retention portion, the main portion having a main portion width and the retention portion comprising a retention width that is greater than the main portion width.

6. The elastic retaining assembly of claim 1, further comprising a plurality of elastically deformable protrusions configured to engage a plurality of receiving features.

7. The elastic retaining assembly of claim 6, wherein the first degree of curvature is substantially straight.

8. The elastic retaining assembly of claim 6, wherein the second degree of curvature is substantially straight.

9. The elastic retaining assembly of claim 6, further comprising at least one standoff operatively coupled to, and extending away from, the first component and configured to engage the second surface of the second component.

10. The elastic retaining assembly of claim 6, further comprising a fully engaged position of the first component, wherein the fully engaged position comprises contact interference between an outer surface of the plurality of elastically deformable protrusions with the plurality of receiving features, wherein an amount of deformation is averaged in aggregate over the plurality of elastically deformable protrusions.

11. The elastic retaining assembly of claim 1, wherein the first component and the second component are vehicle components.

12. The elastic retaining assembly of claim 11, wherein the first component comprises an air deflector and the second component comprises a fascia.

13. An elastic retaining assembly for matable components comprising:
a first component comprising a first surface;
a second component configured to be mated with the first component, the second component comprising a second surface;
a receiving feature formed proximate an engagement side of the second component, the receiving feature comprising main portion and a retention portion proximate an end of the receiving feature; and
an elastically deformable protrusion operatively coupled to, and extending away from, the first component, wherein the elastically deformable protrusion is formed of an elastically deformable material and is configured to elastically deform upon engagement with the receiving feature.

14. The elastic retaining assembly of claim 13, further comprising a fully engaged position of the first component, wherein the fully engaged position comprises contact interference between an outer surface of the elastically deformable protrusion with the receiving feature, wherein an amount of deformation along the outer surface is averaged in aggregate.

15. The elastic retaining assembly of claim 13, further comprising at least one standoff operatively coupled to, and extending away from, the first component and configured to engage the second surface of the second component.

16. The elastic retaining assembly of claim 13, wherein the main portion comprises a main portion width and the retention portion comprises a retention width that is greater than the main portion width.

17. The elastic retaining assembly of claim 13, further comprising a plurality of elastically deformable protrusions configured to engage a plurality of receiving features.

18. The elastic retaining assembly of claim 17, further comprising a fully engaged position of the first component, wherein the fully engaged position comprises contact interference between an outer surface of the plurality of elastically deformable protrusions with the plurality of receiving features, wherein an amount of deformation is averaged in aggregate over the plurality of elastically deformable protrusions.

19. A method of assembling matable components comprising:
inserting an elastically deformable protrusion of a first component into a receiving feature of a second component;
contacting an outer surface of the elastically deformable protrusion with the receiving feature to impose a contact interference condition between the first component and the second component;
bending the elastically deformable protrusion away from a protrusion natural degree of curvature during insertion into the receiving feature; and
elastically deforming the elastically deformable protrusion upon contacting the receiving feature.

20. The method of claim 19, wherein the elastically deformable protrusion comprises a plurality of elastically deformable protrusions, the method further comprising performing an elastic averaging of the elastic deformation over the plurality of elastically deformable protrusions to account for positional variation of the plurality of elastically deformable protrusions.
